(19) United States
(12) Patent Application Publication
(10) Pub. No.: US 2005/0133015 A1
(43) Pub. Date: Jun. 23, 2005

(54) Ball machine mobility mount and a method of using it

(76) Inventors: Thomas Winter, Highland Park, IL (US); Gregory A. Winter, Northaw Park (GB)

Correspondence Address: THOMAS WINTER, 1211 SHERWOOD ROAD, HIGHLAND PARK, IL, 60035, US

(21) Appl. No.: 11/017,029

(22) Filed: Dec. 18, 2004

(30) Foreign Application Priority Data
Dec. 22, 2003 (GB) 0329742.1

(51) Int. Cl. F41B 4/00; B62B 1/00

(52) U.S. Cl. 124/78; 124/80; 280/47.17

(57) ABSTRACT

The present invention comprises a platform on which a ball machine is temporarily mounted and can be secured. Beneath the platform a type of pivot or other variety of mobility providing device(s) is/are attached, to allow the platform to move about in multiple directions and/or rotate. The support platform can be allowed to roll, rotate, tilt and turn while a ball machine is attached to it. Handle(s) can be attached to the platform to allow someone to manually manage/dictate the aim or position of the apparatus, thus control or change the direction of each ball fed when a ball machine is in operation and attached to the structure.

This application claims priority from pending United Kingdom Patent Application No.0329742.1, filed Dec. 22, 2003.

### BACKGROUND OF THE INVENTION

1. Field of Invention

This invention relates to a ball machine mobility mount.

2. Description of Prior Art

Ball machines are used in various sports as practice aids. They feed balls repeatedly to random, coincidental or pre-programmed places/positions. Some ball machines feed balls while oscillating, affecting the direction and placement of each fed ball.

Practicing players suffer from the disadvantage that ball machine feeds are regular, predictable and expected. The machines cannot react to a practicing player's movements or positions, and as a consequence cannot make decisions regarding ball placement or apply tactics according to a given situation/scenario.

### BRIEF SUMMARY OF THE INVENTION

The present invention allows a ball machine to be transported and reduces the predictability of ball feed direction by allowing a ball machine to be aimed or directed manually by an operator, to do this a ball machine is temporarily mounted securely on a ball machine mobility mount.

The present invention comprises a platform on which a ball machine is temporarily mounted and can be secured. Beneath the platform a type of pivot or other variety of mobility providing device(s) is/are attached, to allow the platform to move about in multiple directions, tilt and/or rotate. The support platform can be allowed to roll, rotate, tilt and turn while a ball machine is attached to it. Handle(s) are attached to the platform to allow someone to manually manage/dictate the aim or position of the apparatus, thus control or change the direction of each ball fed when a ball machine is in operation and attached to the structure. The height of the handle(s) can be adjusted by telescopic method, depending on the preference of an operator, and once adjusted may be locked in place via a clamping device for example. The handle(s) can also be, either, detached from the platform or folded against it securely for storage and transport purposes via appropriate means. The mobility mount can also have provisions installed so that it is possible to operate the more sophisticated electronic controls of the ball machine that is attached, such as ball speed, spin, elevation and feed frequency, via a remote control control-panel attached to the handle(s) for instance, giving an operator more options to easily affect the behavior of each ball that is fed. The elements of the ball machine mobility mount as described can be incorporated into the contemporary construction of a ball machine, in that ball machines can be manufactured with motion providing device/s and with handles for the purpose of an operator to manually control/manage/dictate ball feed direction and placement without the use of additional or separate apparatus such as the invented ball machine mobility mount. When a ball machine is mounted on a ball machine mobility mount or when a ball machine is equipped to be operator-controllable, the following training method can be implemented when a practicing player is positioned ready to receive balls being launched from a ball machine under the control of an operator. An operator can determine the placement of each ball machine feed by turning or tilting the ball machine, controlling the approximate location that each ball impacts the ground. An operator can direct ball feeds corresponding to a practicing players position and location.

### BRIEF DESCRIPTION OF THE DRAWINGS

Embodiments of the invention will now be described by way of example with reference to the accompanying drawings. The ball machine mobility mount is illustrated with a ball and holder acting as one example of implementation of a mobility device.

FIG. 1 shows in perspective, the ball machine mobility mount with the ball machine securely mounted in its correct position ready to be directed while operating.

FIG. 2 shows the ball machine mobility mount from above.

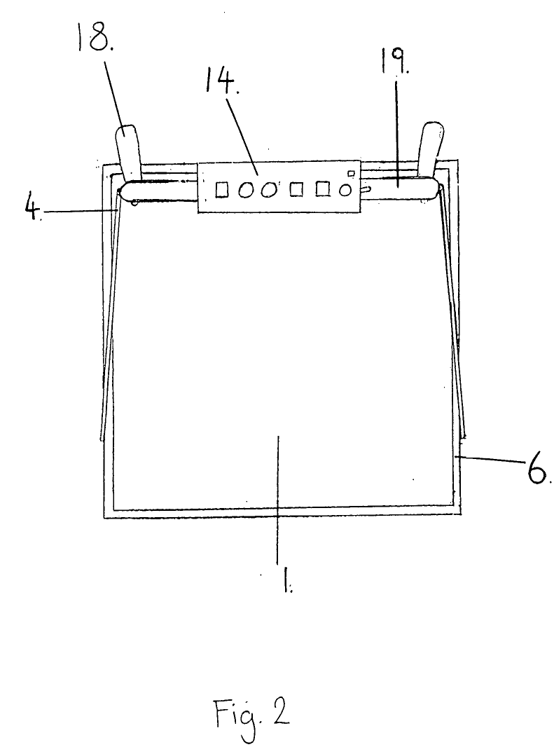

FIG. 3 illustrates the ball machine mobility mount from its profile.

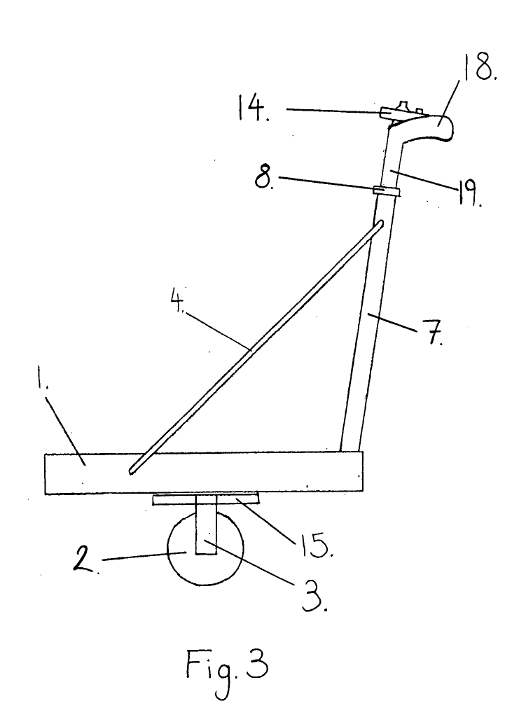

FIG. 4 illustrates the ball machine mobility mount from its front perspective.

FIG. 5 shows the ball machine mobility mount as it appears from below.

FIG. 6 shows a cross section close up of how the upright sleeves are attached and erected to the platform.

### DETAILED DESCRIPTION OF THE INVENTION

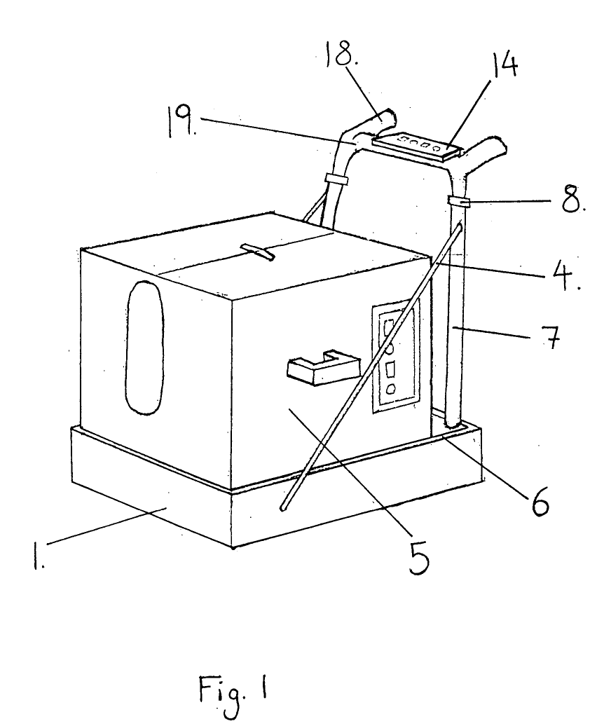

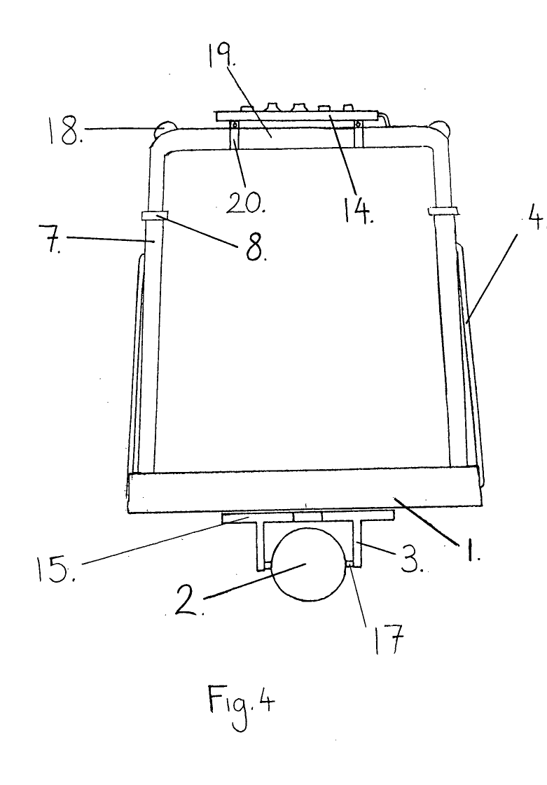

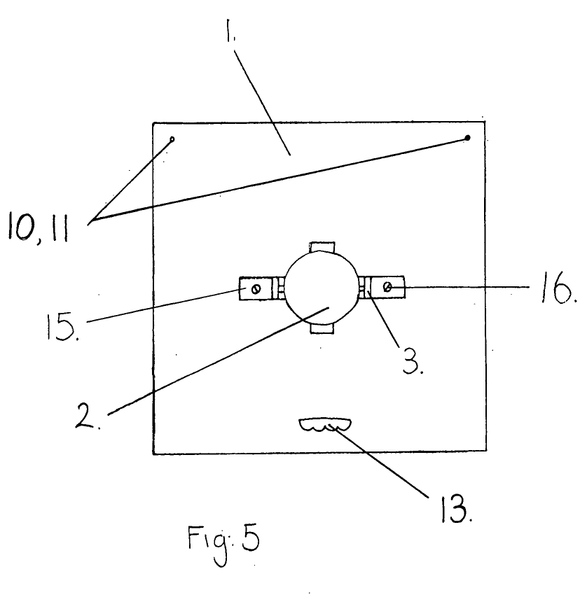

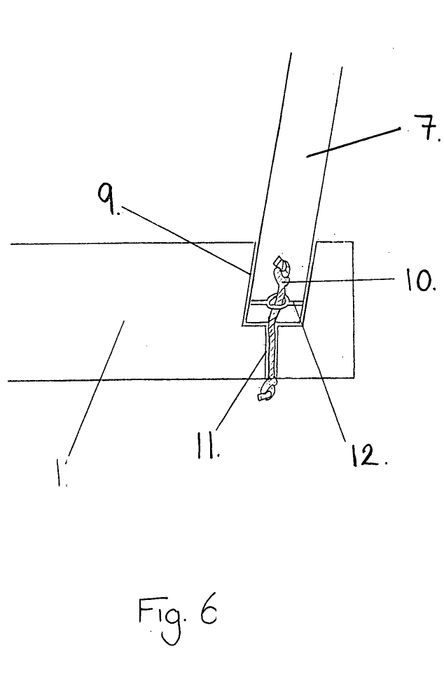

Referring to the drawings the ball machine mobility mount comprises a platform 1, to which a ball machine 5 can be temporarily mounted securely using securing devices such as a raised lip or edge 6 that runs around the perimeter of the platform which secures the ball machine 5 by wedging it in place preventing it from sliding or tipping off the platform 1, as shown in FIG. 1. The handles give an operator means to manage and control the elevation of the apparatus as well as the forward backward and rotational movement of the platform 1 and thus the ball machine 5. The handles are comprising: gripping members 18, their interconnection member 19 and sleeve members 7. The interconnection member 19 slide into sleeve members 7, to form an adjustable telescopic device, and are then locked into place via clamping devices 8, this allows the height of the handles to be adjusted to the preference of an operator. The sleeves 7 are erected and secured to the platform by snugly slotting into shallow cylindrical holes 9 that are set within the upper surface of the platform 1, as shown in FIG. 6. Short durable elastic cords 10 are tied to loops or eyes 12 that are welded inside the bottom ends of the sleeves 7 and are then threaded, from the top of the platform, through small openings 11 at the bottom of each shallow, cylindrical hole 9. The elastic cords 10 are knotted on the other side of the openings 11 on the undercarriage of the platform 1, FIG. 5 and FIG. 6, in such a way that the sleeves 7 are pulled down by the elasticity of the cords but are not pulled taut so that the sleeves 7 cannot be retracted from the holes 9. This method of attaching the sleeves 7 to the platform 1 prevents them from slipping out but still allows them to be easily detached provided adequate force is applied to free the sleeves 7 from the snugly fitted holes 9 and to stretch the elastic cords 10 sufficiently. The combination of the sleeves 7 snugly fitting into the holes 9 and the elastic cords 10 pulling the sleeves 7 down into the holes 9, securely connects and erects the sleeves 7 to the platform 1. The handles 3 i.e. sleeves 7 are removable from the holes 9 in the platform 1, as one body, for transport and storage purposes. Once the handles 3 i.e. sleeves 7 have been removed from the holes 9 in the platform 1 they are allowed to be folded neatly and compactly against the platform's upper surface and are then fastened in place by clipping/wedging them between or within the raised lips or edges 6 of the platform 1. One or plurality of motion providing device/s is/are attached below the platform 1. In the preferred embodiment the motion providing device is built as a ball 2 and a holder, which comprises: a base plate 15 and arms 3, which are attached with screws 16 to the center of the platform's 1 undercarriage, Fig.5. The mobility providing device's ball 2 is held by two pins 17 that protrude from the holder's arms 3 which extend from its base plate 15 that is screwed to the platform 1, FIG. 4. Each pin 17 fits freely into a hole along the ball's central horizontal axis, FIG. 4, allowing the ball 2 to rotate and therefore allowing the apparatus to be rolled back and forth as well as pivoting in multiple directions including; elevation up and down and rotation left and right. This illustrates one possibility in which the platform 1 is made to provide change of the direction, horizontally and vertically in which the mounted ball machine 5 is throwing balls under control of an operator using the handles 3. Braces 4 that attach by clipping devices to the edge of the platform and, when erect, to the sleeves 7, provide the ball machine mobility mount integrity and rigidity. The braces 4 are detachable from the sleeves 7 to allow the sleeves 7 and handles 3 to fold down against the platform 1. Provisions for electronic ball machine controls such as a remote control control-panel 14 are fixed to the interconnection member 19 between the gripping members 18 by fastening device/s 20 as shown in FIGS. 4. This enables an operator to access them easily. An indented grab handle 13 is fabricated as part of the platform's undercarriage so that the apparatus can be easily carried by hand, FIG. 5. When a ball machine is mounted on a ball machine mobility mount or when a ball machine is equipped to be operator-controllable, the following tining method can be implemented when a practicing player is positioned ready to receive balls being launched from a ball machine under the control of an operator. An operator can determine the placement of each ball machine feed by turning or tilting the ball machine, controlling the approximate location that each ball impacts the ground. An operator can direct ball feeds corresponding to a practicing players position and location.

The foregoing exemplary description and the illustrative preferred embodiments of the present invention have been explained in the drawings and described in detail, with varying modifications being taught. While the invention has been so shown, described and illustrated, it should be understood by those skilled in the art that equivalent changes in form and detail may be made therein without departing from the true spirit and scope of the invention, and that the scope of the present invention is to be limited only to the claims, except as precluded by the prior art. Moreover, the invention as disclosed herein may be suitably practiced in the absence of the specific elements that are disclosed herein. The elements of the ball machine mobility mount as described and claimed can be incorporated into the contemporary construction of a ball machine, in that ball machines can be manufactured with motion providing device/s and with handles for the purpose of an operator to manually control/manage/dictate ball feed direction and placement without the use of additional or separate apparatus such as the invented ball machine mobility mount.

1. A ball machine mobility mount for a ball machine comprising:
a. a platform;
b. one or plurality of mobility providing devices;
c. one or plurality of handles; and
d. one or plurality of securing devices;
wherein said platform is used to support a ball machine detachably secured to it by said
securing devices and wherein to said platform said mobility providing device is attached to provide desired movement of said platform rotationally and directionally using any angle horizontally and/or vertically and any direction left or right, and/or forward backward as desired and said platform having one or plurality of said handles attached to it so that said handles are used by an operator to control movement of said ball machine in said desired directions.

2. A ball machine mobility mount as claimed in claim 1; wherein said mobility device comprises:
a. a ball;
b. a base plate;
c. two arms; and
d. an axel;
wherein said ball is rotatably mounted on said axel that is attached to said two arms which are providing a support for said axel and said ball and are attaching them irremovably to said base plate which is used to attach irremovably said mobility device to said platform.

3. A ball machine mobility mount as claimed in claim 1 and 2; wherein said mobility device is irremovably fixed to said platform by using screws.

4. A ball machine mobility mount as claimed in claim 1 and 2; wherein said mobility device is irremovably fixed to said platform by using glue.

5. A ball machine mobility mount as claimed in claim 1; wherein a ball machine is detachably secured to said platform by using a raised lip that runs partially around the perimeter of the platform to secure the ball machine by wedging it in place preventing it from sliding or tipping off the platform.

6. A ball machine mobility mount as claimed in claim 1; wherein a ball machine is detachably secured to said platform by using a raised lip that runs partially around the perimeter of the platform to secure the ball machine by wedging it in place to prevent it from sliding or tipping off the platform.

7. A ball machine mobility mount as claimed in claim 1; wherein a ball machine is detachably secured to said platform by using a raised edge that runs around the perimeter of the platform to secure the ball machine by wedging it in place to prevent it from sliding or tipping off the platform.

8. A ball machine mobility mount as claimed in claim 1; wherein handles comprise:
a one or plurality of gripping members;
b. one or plurality of sleeve members; and
c. one or plurality of locking devices;
wherein gripping members are slidably interconnected with sleeve members to form a telescopic arrangement in order to provide for length of said handles to be variably adjusted to the need of an operator, and wherein clamping devices are used to lock in a desired position said gripping and sleeve members once when desired length of said handles is set.

9. A ball machine mobility mount as claimed in claim 1 or 8; wherein said handles are connected to said platform by such connecting devices that allow them to be detachably fixed in a working position and to be detachably fixed in a storing position without disconnecting them from said platform.

10. A ball machine mobility mount as claimed in claim 10; wherein said handles are attached to said platform using elastic cord.

11. A ball machine mobility mount as claimed in claims 1; wherein said handles have a support platform such that it is used to attach to it a ball machine electronic controls; and wherein said electronic controls are used to operate the ball machine's functions.

12. ball machine mobility mount as claimed in claims 1; wherein one or plurality of detachable braces are attached between said platform and said handles in order to secure integrity and rigidity of the said ball machine mobility mount.

13. A ball machine mobility mount as claimed in claims 1; having one or plurality of carrying handles.

14. A ball machine having a mobility providing device permanently attached to it providing desired movement of said ball machine rotationally and directionally using any angle horizontally and/or vertically and any direction left or right, and/or forward backward as desired and said ball machine having one or plurality of handles attached to it so that said handles are used by an operator to control movement of said ball machine in said desired directions.

15. A ball machine as claimed in claim 15; wherein said mobility device comprises:
a. a ball;
b. a base plate;
c. two arms; and
d. an axel; wherein said ball is rotatably mounted on said axel that is attached to sad two arms which are providing a support for said axel and said ball and are attaching them irremovably to said base which is used to attach irremovably said mobility device to said ball machine.

16. A ball machine as claimed in claim 15; wherein handles comprise:
a. one or plurality of gripping members;
b. one or plurality of sleeve members; and
c. one or plurality of locking devices;
wherein gripping members are slidably interconnected with sleeve members to form a telescopic arrangement in order to provide for length of said handles to be variably adjusted to the need of an operator; and wherein locking devices are used to lock in a desired position said gripping and sleeve members once when desired length of said handles is set.

17. A ball machine as claimed in claims 15 and 17; wherein said handles are having a support platform such that said ball machine's electronic controls can be fixed to it; and wherein said electronic controls are used to operate said ball machine's functions.

18. A method of training of a player by an operator positioned opposite to said player having a ball machine mounted on a ball machine mobility mount or by using a ball machine equipped to be operator controllable; and wherein said operator partially or fully in real-time determines the trajectory of the current ball and the moment when it will be launched using said players reactions and position to the precedingly launched ball to select parameters determining said ball's trajectory.

19. A method of training of a player as claimed in claim 19; where in trajectory of the ball is controlled by an angle and/or direction and/or speed and/or spin and/or approximate location of an impact of said ball.
